(19) United States
(12) Patent Application Publication
(10) Pub. No.: US 2024/0118089 A1
(43) Pub. Date: Apr. 11, 2024

(54) PATH PLANNING GRAPH GENERATION AND REAL-TIME PATH PLANNING FOR AUTONOMOUS VEHICLES

(71) Applicant: Verity AG, Zurich (CH)

(72) Inventors: Antonio Terpin, Zurich (CH); Tomislav Horvat, Baden (CH); Markus Florian Hehn, Zurich (CH)

(21) Appl. No.: 18/378,525

(22) Filed: Oct. 10, 2023

Related U.S. Application Data
(60) Provisional application No. 63/415,132, filed on Oct. 11, 2022.

(51) Int. Cl. G01C 21/20

(52) U.S. Cl. CPC G01C 21/206

(57) ABSTRACT

Systems and methods are provided for generating path planning graphs. A free space map is accessed comprising a plurality of geometric elements. For each geometric element, boundary jump surfaces are defined and propagated through neighboring geometric elements, and for each geometric element boundary through which a boundary jump plan is propagated, one or more transition jump surfaces are defined. A path planning graph is generated based on the defined boundary jump surfaces and transition jump surfaces. Additional starting and ending jump surfaces may be defined for the starting and ending point of a path. Systems and methods are also provided for determining paths. Costs are assigned to a plurality of available path segments based on data indicating risk of encountering obstacles and the path is determined from a starting point to an ending point based on the assigned costs.

### CROSS-REFERENCE TO RELATED APPLICATIONS

This application claims priority to U.S. Provisional Patent Application No. 63/415,132, filed on Oct. 11, 2022, the entire contents of which are hereby expressly incorporated by reference in their entirety.

### INTRODUCTION

The present disclosure is directed to generating path planning graphs and real-time path planning for autonomous vehicles. More particularly, the present disclosure is directed to generating computationally efficient path planning graphs and computationally efficient real-time path planning and replanning for obstacle avoidance. The present disclosure is also directed to path planning to reduce the risk of encountering an obstacle.

### SUMMARY

Real-time path planning for aerial vehicles in large facilities represents an open challenge when it comes to reliability, optimality, and computational efficiency. Many tasks in, for example, warehouses require a precise path to follow. The energetic constraints of unmanned aerial vehicles generally impose strong requirements in terms of optimality of the considered trajectories. The importance of completing tasks requires high levels of reliability. For instance, if the path planner fails to re-plan in air, the battery will drain and the vehicle will either land or, in the worst case, crash. Path planning techniques may, for example, solve shortest path problems either via approximations, which may be unreliable, or via exact solutions that may be computationally too demanding to be feasible within the operational constraints.

The present disclosure provides methods and systems for constructing path planning graphs (e.g., for a large warehouse). The present disclosure also provides methods and systems for dynamically adjusting path planning graphs to the planning goal points and restricts the configuration space to one small enough to perform optimization algorithms in real-time (e.g., A* search algorithms). Accordingly, the present disclosure provides sufficient guarantees without hampering real-time implementations, which may be needed for replanning when encountering an unpredicted obstacle.

Autonomous vehicles (e.g., autonomous mobile robots) generally need to use a path planner to move in an environment. The intrinsic uncertainties in any real-world environment mapping (e.g., in a warehouse) enforces the need for real-time replanning (e.g., online in the autonomous vehicle). For example, a warehouse may not have wireless communication coverage (e.g., Wi-Fi coverage) throughout the entire environment. Therefore, if an unknown obstacle is encountered in a location without wireless communication, or a movable obstacle is encountered in an unexpected location, replanning will need to be performed onboard the autonomous vehicle. Accordingly, real-time planning is important for the reliable deployment of autonomous systems. When it comes to reliability, optimality, and computational efficiency, the present disclosure provides an effective framework to perform such planning. Therefore, in some embodiments, the present disclosure represents a building block that could be used by others when creating a robotic system for defining trajectories to follow.

In some embodiments, the present disclosure enables autonomous vehicles to navigate in erroneous, uncertain, or dynamic environments. In some embodiments, the present disclosure generates constrained optimization problems or combinatorial problems for solving.

In view of the foregoing, the present disclosure provides a framework for reducing a continuous space to an optimized discrete configuration space (e.g., for combinatorial optimization). The optimized discrete configuration space enables algorithms to operate more efficiently (e.g., when exploring the space to find a solution). The present disclosure is applicable to a wide range of environments, including large indoor facilities as well as for outdoor environments.

In some embodiments, methods and systems are provided for generating a path. A free space map comprising geometric elements is accessed. For each of the geometric elements, the following are performed: boundary jump surfaces are defined; for each of the boundary jump surfaces that reaches a geometric element boundary where a neighboring geometric element is present, the boundary jump surface is propagated to the neighboring geometric element; and for each geometric element boundary through which a boundary jump surface is propagated, a transition jump surface is defined. The path planning graph is generated based on the boundary jump surfaces and the transition jump surfaces defined for the plurality of geometric elements. Boundary jump surfaces and transition jump surfaces are collectively referred to herein as jump surfaces.

In some embodiments, for each geometric element of the free space map, a neighbor geometric element is defined. In some embodiments, for each face of each geometric element, a boundary jump surface is defined, where the boundary jump surface is parallel to the face.

In some embodiments, for each of the geometric elements, one or more boundary jump surfaces that do not reach a neighboring geometric element are discarded.

In some embodiments, each transition jump surface is defined as a line or surface parallel to the geometric boundary through which a boundary jump surface is propagated.

In some embodiments, each of the geometric elements comprises a plurality of geometric element boundaries and each boundary jump surface is defined as being parallel to a respective geometric element boundary.

In some embodiments, the geometric elements correspond to three-dimensional boxes and six boundary jump surfaces are defined for each geometric element.

In some embodiments, a path from a starting point to an ending point is determined based on the path planning graph. A plurality of surfaces containing the starting point, referred to as starting jump surfaces, are defined from the starting point within one of the plurality of geometric elements. Similarly, a plurality of surfaces containing the ending point, referred to as ending jump surfaces, are defined from the ending point within another one of the plurality of geometric elements. In some embodiments, for each geometric element neighboring to a geometric element to which a starting jump surface is associated, the starting jump surface is propagated to the neighbor geometric element if it is intersected by the starting jump surface. In some embodiments, for each geometric element neighboring to a geometric element to which an ending jump surface is associated, the ending jump surface is propagated to the neighbor geometric element if it is intersected by the ending jump surface. The path planning graph can be further based on the plurality of starting jump surfaces and/or the plurality of ending jump surfaces.

In some embodiments, a path will result in a collection of path points that the autonomous vehicle can follow sequentially without hitting any known obstacle (e.g., walls in a warehouse). Any two consecutive path points define a path segment. In some embodiments, the autonomous vehicle may move in a line between two consecutive points. In some other embodiments, the autonomous vehicle may follow other curves (e.g., a polynomial curve). The curves may be determined according to any algorithm that generates a feasible curve, for instance an optimization algorithm which accounts for the dynamics of the autonomous vehicle. The collection of points may be along one starting jump surface, one ending jump surface, and one or more of the boundary jump surfaces and transition jump surfaces. Accordingly, boundary jump surfaces, transition jump surfaces, starting jump surfaces, and ending jump surfaces are also collectively referred to herein as jump surfaces.

In accordance with some embodiments of the present disclosure, methods and systems are provided for determining a path based on risk of encountering an unknown or unexpected obstacle. Objects that are not known or whose location is not known before the autonomous vehicle starts moving are referred to herein as obstacles, as opposed to blocked spaces. For example, in a warehouse environment, the walls of a warehouse may be considered blocked spaces, whereas a forklift may be considered an obstacle. It will be understood that an obstacle may be assigned to different categories in different embodiments, possibly resulting in inefficiencies or errors. In accordance with the present disclosure, costs may be assigned to available path segments. For example, the costs may be assigned to each segment based on data indicating risk of encountering obstacles. A path from a starting point to an ending point is determined based on the assigned costs.

In some embodiments, at least one assigned cost is modified based on data indicating a change in risk of encountering an obstacle. For example, recent historical data may indicate a decrease or increase in the risk of encountering an obstacle. Accordingly, modifying costs may include decreasing the cost of a first path segment based on historical data indicating a low risk of encountering an obstacle on the first path segment and increasing the cost of a second path segment based on historical data indicating a high risk of encountering an obstacle on the second path segment. With such modified costs, the determined path may include the first path segment and exclude the second path segment. This may result in a total path length that is longer than a path that were to include the second path segment, but the selected path may be less likely to need replanning due to the encounter of an obstacle.

In some embodiments, one or more of the assigned costs are reset at least once a day (e.g., in a warehouse environment).

In some embodiments, a decreased cost of a first path segment corresponds to an increased path speed for the first path segment and an increased cost of a second path segment corresponds to a decreased path speed. In other words, a path segment having a lower level of risk of encountering an obstacle has a higher path speed than a path segment having a higher level of risk of encountering an obstacle.

In some embodiments, assigning the costs to a plurality of available path segments comprises: determining a path speed for each path segment based on data indicating risk of encountering an obstacle along the path segment, and estimating a travel time for each path segment based on the determined path speeds, where the assigned costs correspond to the estimated travel times of the plurality of available path segments.

The determined path speeds for available path segments may include a low path speed and a high path speed. In some embodiments, the low path speed corresponds to a speed at which a drone is expected to be able to stop in time when a sensor of the drone detects an obstacle, and the high path speed corresponds to a speed that exceeds an expected stopping ability of the drone when the sensor of the drone detects an obstacle. In some embodiments, in response to a drone traveling a first available path segment without encountering an obstacle, the path speed for the first available path segment is changed to a high path speed that exceeds an expected stopping ability of the drone when the sensor of the drone detects an obstacle.

In accordance with some embodiments of the present disclosure, methods and systems are provided for navigating an autonomous vehicle along the path, identifying an obstacle along the path, accessing a path planning graph, generating a modified path planning graph based on the obstacle and the accessed path planning graph, and determining an alternate path to the destination based on the modified path planning graph. In some embodiments, an obstacle may expire and in response to determining that the obstacle expired, the path planning graph is restored. Determining whether the obstacle expired may include setting a timer and determining whether the timer has expired. As another example, determining whether the obstacle expired may include determining whether the obstacle is detected when an autonomous vehicle passes near the obstacle. In some embodiments, the path planning graph comprises a plurality of surfaces representing possible path segments and generating the modified path planning graph comprises replacing a surface that passes through the obstacle with a shortened surface or removing a segment of the surface that passes through the obstacle.

In some embodiments, the systems of the present disclosure include a memory storing instructions and processing circuitry configured to execute the instructions stored in the memory to perform the methods of the present disclosure. In some embodiments, the memory comprises non-transitory computer-readable medium comprising non-transitory computer-readable instructions encoded thereon, which when executed by processing circuitry, cause the methods of the present disclosure to be performed. The processing circuitry of the present disclosure may be implemented on a single device or may be distributed across multiple devices, systems, or networks.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows a block diagram of an illustrative system, in accordance with some embodiments of this disclosure;

FIG. 2 shows a block diagram of an illustrative drone, in accordance with some embodiments of this disclosure;

FIG. 3A shows a warehouse environment having blocked spaces and/or obstacles, in accordance with some embodiments of this disclosure;

FIG. 3B shows a free space map of the warehouse environment of FIG. 3A, in accordance with some embodiments of this disclosure;

FIG. 4 shows a path planning grid;

FIG. 5A shows a two-dimensional world defined by a free space boundary, in accordance with some embodiments of this disclosure;

FIG. 5B shows a free space map of the two-dimensional world of FIG. 5A, in accordance with some embodiments of this disclosure;

FIGS. 6A-F show a method of generating a path planning graph based on the free space map of FIG. 5B, in accordance with some embodiments of this disclosure;

FIGS. 6G-I show a method of using the path planning graph of FIG. 6F to determine a path from a starting point to an ending point, in accordance with some embodiments of this disclosure;

FIG. 7 is a flowchart of an illustrative process for generating a path planning graph, in accordance with some embodiments of this disclosure;

FIG. 8A shows two paths to an ending point in a warehouse environment, in accordance with some embodiments of this disclosure;

FIG. 8B shows a path obstacle and an alternative path in the warehouse environment of FIG. 8A, in accordance with some embodiments of this disclosure;

FIG. 9 is a flowchart of an illustrative process for performing path replanning during navigation when an obstacle is identified, in accordance with some embodiments of this disclosure; and

FIG. 10 is a flowchart of an illustrative process for performing path planning based on assigned costs, in accordance with some embodiments of this disclosure.

### DETAILED DESCRIPTION

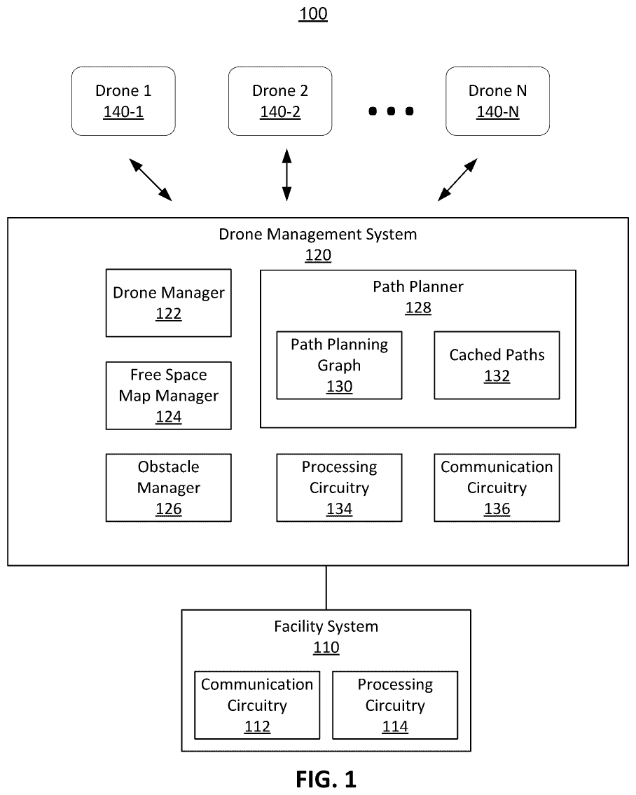

FIG. 1 shows a block diagram of an illustrative system 100, in accordance with some embodiments of this disclosure. System 100 may be implemented in any suitable environment or facility. For example, system 100 may be implemented in a warehouse or other location (e.g., a large distribution facility) that stores and manages goods, materials, or any other types of objects. System 100 as illustrated includes a facility system 110 and drone management system 120.

Facility system 110 may control the environment or facility operations. For example, where system 100 is implemented in a warehouse environment, facility system 110 may control warehouse operations starting from when items enter the warehouse until the objects leave the warehouse. Facility system 110 may also manage warehouse tasks such as the picking of items from shelves for shipping and storing received items on shelves (e.g., by generating inventory moving tasks) and performing inventory checks (e.g., by generating inventory validation tasks).

Facility system 110 is communicatively coupled to drone management system 120. Facility system 110 may generate tasks for drone management system 120 to perform. For example, facility system 110 may request drone management system 120 to send drones to various locations within the facility to retrieve items, store items, or perform inventory validation tasks.

Facility system 110 may comprise processing circuitry 114 which may comprise hardware, software or any combination thereof, such as, for example, one or more central processing units (CPUs) configured to execute instructions stored in computer-readable media (e.g., memory) to implement operating system(s) and applications of facility system 110 and perform and/or control various operations and tasks of the facility. Facility system 110 may further comprise communication circuitry 112 configured to transmit and receive communications from drone management system 120. Communication circuitry 112 may also be configured to transmit and receive communications between other components within system 100, such as drones 140.

The memory of processing circuitry 114 may comprise one or more of, for example, Random Access Memory (RAM), Read Only Memory (ROM), EEPROM, ASIC, optical storage, magnetic storage, flash memory, solid state memory, or any combination thereof, or any other suitable medium used to store data. The memory may be configured to store one or more instructions (e.g., in the form of an application) executable by processing circuitry 114 to, for example, manage the locations of objects in the warehouse and request inventory validation tasks. Any suitable programming language may be employed to implement such instructions and applications, e.g., Java, C, C++, Python, Go, JavaScript, Typescript, etc.

Drone management system 120 controls drones 140-1, 140-2, . . . , and 140-N (collectively referred to as drones 140) within the warehouse, where N is an integer. As shown, drone management system 120 is communicatively coupled to drones 140, and facility system 110. As shown, drone management system 120 may comprise a plurality of modules (e.g., drone manager 122, free space map manager 124, obstacle manager 126, path planner 128, path planning graph 130, and cached paths 132) and processing circuitry 134 which may comprise hardware, software or any combination thereof, such as, for example, one or more central processing units (CPUs) configured to execute instructions stored in computer-readable media (e.g., memory) to implement operating system(s) and applications of drone management system 120 and manage task for drones 140. In some embodiments, processing circuitry 134 implements one or more of the plurality of modules (e.g., 122-132). Drone management system 120 may further comprise communication circuitry 136 configured to transmit and receive communications from/to drones 140 and facility system 110. Communication circuitry 136 may also be configured to transmit and receive communications between components within drone management system 120. In some implementations, drone management system 120 may retrieve information from facility system 110 using an API.

The memory of processing circuitry 134 may comprise one or more of, for example, Random Access Memory (RAM), Read Only Memory (ROM), EEPROM, ASIC, optical storage, magnetic storage, flash memory, solid state memory, or any combination thereof, or any other suitable medium used to store data. The memory may be configured to store one or more instructions (e.g., in the form of an application) executable by processing circuitry 134 and/or the plurality of modules (e.g., 122-132) to, for example, manage tasks such as inventory validation tasks and perform path planning. Any suitable programming language may be employed to implement such instructions and applications, e.g., Java, C, C++, Python, Go, JavaScript, Typescript, etc.

Drone management system 120 controls drones 140 to perform tasks, such as the inventory validation tasks received from facility system 110. For example, drone management system 120 may receive tasks from facility system 110 and store the tasks in a tasks database. Drone management system 120 may then assign the tasks to specific ones of drones 140 to perform. In some embodiments, when assigning tasks, drone management system 120 may perform path planning to determine the paths for drones 140 to follow to their destinations. In some embodiments, drones 140 are autonomous aerial vehicles (e.g., aerial robots) that are capable of navigating through an environment to specific locations and performing replanning during navigation to avoid, for example, obstacles and blocked spaces. For example, drone management system 120 may determine a path for a specific drone 140 to follow and then transmit the determined path to the drone, along with path planning graph 130 and/or cached paths 132 or a free space map to enable the drone to perform real-time path replanning when an obstacle or blocked space is encountered. In some embodiments, drone management system 120 does not perform path planning for drones 140. Instead, drones 140 receive their assigned tasks from drone management system 120 and drones 140 perform path planning to determine paths to follow to perform their assigned tasks. Drones 140 may include one or more sensors such as a camera that are used to capture images of locations in the facility to, for example, identify items in the facility and identify obstacles. Captured images and/or data can be used to monitor the status of obstacles by obstacle manager 126 and/or validate location information by facility system 110.

Drone manager 122 may maintain a database of information about drones 140. The information may include properties and current status information of each drone 140 (e.g., static and dynamic information). For example, for each drone 140, drone manager 122 may store drone properties such as size, maximum velocity and acceleration, communication information, etc. (e.g., static information), as well as current status such as current location (e.g., within an environment), current charge level, current available flight time, etc. Drone manager 122 may periodically (or in real-time) update the current status of each drone 140 based on information (e.g., telemetry) received from the drone through communication circuitry 136.

Drone manager 122 may also coordinate operations of drones 140. In some embodiments, drone manager 122 instructs drones 140 to fly along paths determined by path planner 128 to desired locations within the facility, for example, to perform specified operations such as inventory validation tasks. In some embodiments, drone manager 122 transmits the tasks to respective drones 140. The transmitted tasks may include locations to visit and the drones 140 may perform path planning to determine paths to visit the locations.

Free space map manager 124 maintains a representation of the free space of an environment such as a warehouse environment. Free space map manager 124 may also maintain a map of the space of the overall environment and receive obstacle and blocked space information from obstacle manager 126. In some environments, there are blocked spaces (e.g., walls and columns) as well as obstacles (e.g., an inventory item, movable storage racks, forklifts, etc.). In some embodiments, obstacle manager 126 manages the locations of obstacles (e.g., a forklift blocking an aisle in a warehouse) and provides the obstacle and blocked space information to free space map manager 124. Obstacle manager 126 may receive information about obstacles from drones 140 as they navigate through an environment and encounter obstacles or detect the presence of obstacles using one or more sensors. Free space map manager 124 may maintain a free space map of the environment based on blocked space and may also maintain a dynamic or real-time free space map based on blocked space as well as obstacles.

Path planner 128 determines paths (e.g., obstacle-free paths) for drones 140 to navigate along to reach desired destinations in the environment (e.g., to carry out a task specified by facility system 110). As will be described in further detail below, path planner 128 may use a path planning graph 130 and cached paths 132 to determine the optimal paths for drones 140. Path planning graph 130 encodes a reduced set of potential paths that can be used for navigating through a free space environment (e.g., as defined by the free space map maintained by free space map manager 124). Path planning graph 130 may be represented in any suitable form. For example, path planning graph 130 may be represented by a set of nodes or available path segments. In some embodiments, path planning graph 130 represents an optimized reduced set of potential paths as explained in more detail below. Cached paths 132 represent previously determined paths that have been followed by drones 140. As part of cached paths 132 or separately, historical data may also be stored indicating how many times cached paths 132, or segments thereof, have been successfully traveled and how many times obstacles were encountered. The historical data can be used to determine the risk of encountering an obstacle on any given path segment of cached paths 132 or any path segment within the free space environment. In some embodiments, the risk can be determined by dividing the number of times an obstacle was encountered on a path segment by the number of times the path segment was navigated. In some other embodiments, the risk can be determined using other statistical methods. In some embodiments, the risk on one path segment may be calculated considering the number of encounters in other path segments. For example, if the encountered obstacle is a forklift, the obstacle may be located to nearby locations at a later time. In some embodiments, the calculated values represent a level of risk of encountering an obstacle along a path segment. Path planner 128 may use the historical data to select path segments that have lower risk of encountering an obstacle, even if this means that the determined paths will be longer than other possible paths that have a higher risk of encountering an obstacle. In some embodiments, path planner 128 determines a path speed for a determined path. The path speed may be determined based on the level of risk of encountering an obstacle. For example, faster path speeds may be assigned to path segments having lower levels of risk of encountering obstacles.

Drone management system 120 may be communicatively connected to facility system 110 by an integration layer that connects application programming interfaces (APIs) of the two systems. In some embodiments, facility system 110 and drone management system 120 may be remote systems that communicate with each other over the Internet or other suitable communication interfaces. It will be understood that while facility system 110 and drone management system 120 are depicted as separate systems, in some embodiments, the functionality can be included in a single system. For example, the single system may include two subsystems, one for implementing the functionality of facility system 110 and another for implementing the functionality of drone management system 120. As another example, the functionality performed by drone management system 120 may be included in facility system 110. It will also be understood that one or more aspects of facility system 110 and drone management system 120 may be implemented in the cloud. For example, path planner 128 may be cloud-based and accessible to facility system 110, drone management system 120, and/or drones 140.

It will be understood that in some embodiments, drone management system 120 may not perform path planning and the path planning functionality may be included in each of the drones 140. For example, each drone may include a free space map 124, an obstacle manager 126, and a path planner 128, which includes path planning graph 130 and cached paths 132. Even though drone management system 120 may not perform path planning, it may maintain the information that is used by drones 140 for performing path planning. For example, drone management system 120 may store the free space map, the locations of obstacles, a path planning graph, and cached paths. When drones 140 encounter obstacles, they are able to handle the obstacles independently (e.g., by performing replanning). In some embodiments, drone management 120 collects data from drones 140 (e.g., the location of encountered obstacles) and shares the data with all of drones 140. For example, when a drone 140 encounters an obstacle, it performs path replanning autonomously (e.g., using an onboard obstacle manager 126 and an onboard path planner 128) and at that time or later when the task is complete, drone 140 provides the obstacle information to drone management system 120. Drone management system 120 may maintain this information (e.g., in the modules or subsystems describes above) and share the information with other drones 140 at a later time.

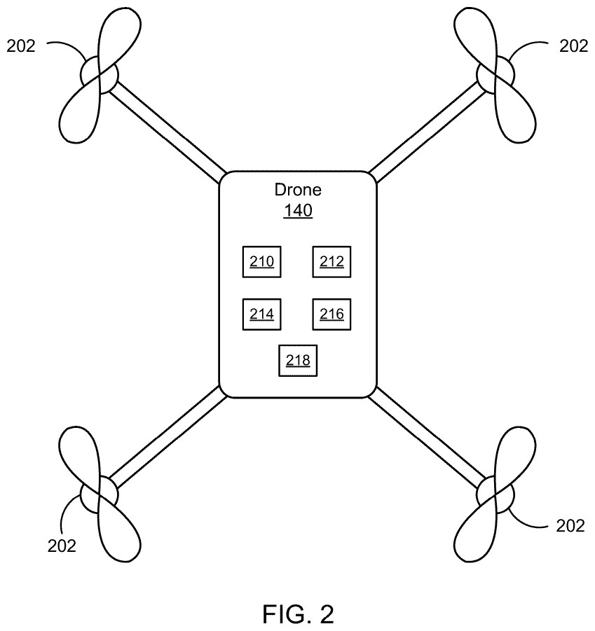

FIG. 2 shows a block diagram of an illustrative drone 140, in accordance with some embodiments of this disclosure. Drone 140 includes four actuators 202 that are used to rotate respective propellers that allow the drone 140 to fly and control its movement through space. Drone 140 may also include one or more sensors 210 that are used to assist in navigating through space. Sensors 210 may include a localization sensor (e.g., an indoor positioning sensor) for determining the position of drone 140. For example, when drone 140 is used with system 100 of FIG. 1, the localization sensor can be used to determine the position of drone 140 in an environment such as a warehouse based on signals from anchors positioned within the warehouse. In another example, the signals may come from drone 140 and be reflected from the anchors. Sensors 210 may also include collision avoidance sensors such vision sensors, ultrasonic sensors, infrared (IR) sensors, LiDAR sensors, or the like.

Drone 140 may comprise communication circuitry 212 configured to transmit and receive communications from, for example, drone management system 120. For example, drone 140 may receive one or more tasks from drone management system 120, and in some embodiments may receive one or more paths to navigate along to perform the one or more tasks. Drone 140 may also receive path planning graph 130, cached paths 132, obstacles from obstacle manager 126, and a free space map from free space map manager 124 to enable drone 140 to perform real-time path planning and replanning (e.g., when encountering an obstacle along a path). Drone 140 may also comprise memory 216 for storing the tasks, paths, path planning graph 130, cached paths 132, a free space map, and/or obstacle information. Memory 216 may comprise one or more of, for example, Random Access Memory (RAM), Read Only Memory (ROM), EEPROM, ASIC, optical storage, magnetic storage, flash memory, solid state memory, or any combination thereof, or any other suitable medium used to store data.

Drone 140 may comprise processing circuitry 214 configured to manage the operation of drone 140. Processing circuitry 214 may comprise hardware, software or any combination thereof, such as, for example, one or more central processing units (CPUs) configured to execute instructions stored in non-transitory computer-readable media (e.g., memory 216) to implement operating system(s) and applications (e.g., route navigation and path planning and replanning of path planner 128). For example, processing circuitry 214 may navigate drone 140 along a path to a destination and when an obstacle is encountered, perform path replanning based on, for example, path planning graph 130 and/or cached paths 132 as described in further detail below. Processing circuitry 214 may transmit, using communication circuitry 212, information about encountered obstacles to drone management system 120 or obstacle manager 126.

In some embodiments, it will be understood that drone 140 may include free space map manager 124, obstacle manager 126, and path planner 128 to perform path planning and replanning.

Drone 140 may comprise camera 218 configured to capture images. Camera 218 may be used by drone 140 to capture images of locations within, for example, an environment such as a warehouse. The images can be used to perform tasks such as inventory validation tasks by, for example, comparing barcode data from the image to a target barcode expected to be at the location. In some embodiments, communication circuitry 212 may transmit the captured image to drone management system 120 such that drone management system 120 performs the comparison.

The methods of the present disclosure can be implemented on any one or a combination of processing circuitry 114, 134, and 214. Accordingly, it will be understood that processing circuitry, as used herein, includes processing circuitry distributed across multiple devices, system, or networks. It will also be understood that the processing circuitry may be configured to execute instructions stored in non-transitory computer-readable media and such media and stored instructions may also be distributed across multiple devices, system, or networks.

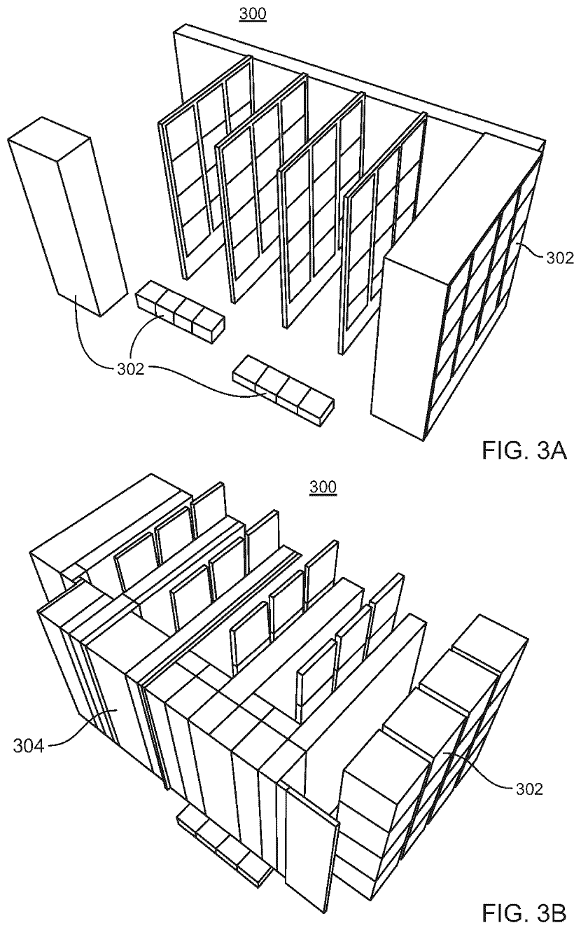

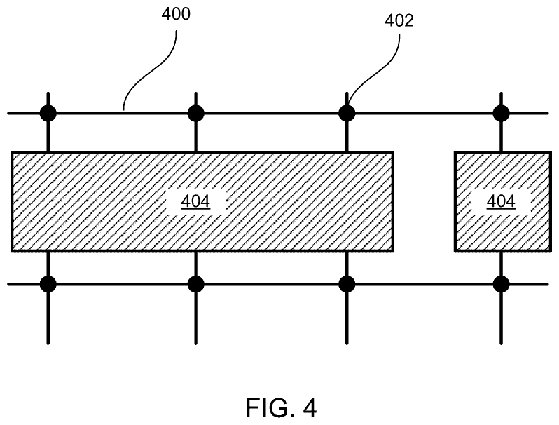

FIG. 3A shows a warehouse environment 300 having blocked spaces and/or obstacles 302, in accordance with some embodiments of this disclosure. Blocked spaces and/or obstacles 302 may include one or more building columns, walls, storage racks, pallets, forklifts, any other objects, or any combination thereof. In some embodiments, over time, obstacles may appear, disappear, and move within the depicted warehouse environment. In some embodiments, as shown, blocked spaces and/or obstacles 302 are represented as geometric shapes. Blocked spaces and/or obstacles 302 may be stored and manipulated by obstacle manager 126. It will be understood that some blocked spaces may also change over time. The different time scale allows for adapting the blocked space without limiting the applicability of the methods described in this disclosure.

FIG. 3B shows a free space map 304 of warehouse environment 300 of FIG. 3A, in accordance with some embodiments of this disclosure. Free space map 304 may comprise a plurality of geometric elements that fill the free space. In some embodiments, the geometric elements are axis-aligned boxes. As illustrated, free space map 304 comprises a plurality of three-dimensional axis-aligned boxes. Free space map 304 may be stored and manipulated by free space map manager 124.

FIGS. 3A and 3B represent obstacles and free space in the form of axis-aligned bounding boxes, which are convenient bounding volumes. For example, a ball on the floor of the warehouse environment can be represented by obstacle manager 126 as a cube enclosing the ball. In some embodiments, the free space map 304 is known and stored (e.g., in memory of drone management system 120 and/or drones 140). In some embodiments, free space map 304 is generated by free space map manager 124 and updated based on identified obstacles in an environment.

In some embodiments, a free space map is generated for the entire environment being mapped. The process (e.g., performed by free space map manager 124 and/or obstacle manager 126) may begin by defining a world box, W, which is a three-dimensional box enclosing the environment (e.g., a warehouse building in which an autonomous vehicle may navigate). The set of blocked spaces and obstacles in the environment may be referred to as B and each element can be described by a three-dimensional axis aligned bounding box. Some elements may be described by a set of axis-aligned boxes, at any desired resolution. Given two boxes b1, b2, b1\b2 is defined as the set of boxes B12 such that {b2} U B12 is a partition of b1 in the set theoretic sense of R\hat{ }3. The following is an illustrative algorithm for generating a free space map, FSM:

| | |
|---|---|
| 1. | FSM = {W} |
| 2. | For all b2 in B: |
| 3. | For all b1 in FSM: |
| 4. | FSM = FSM U (b1/b2) |
| 5. | End For |
| 6. | End For |

In summary, the illustrative algorithm starts by initializing the free space map as being equal to the entire world box. Then, each blocked space and/or obstacle is subtracted from the free space map such that the remaining set of boxes fill the entire free space.

The foregoing illustrative algorithm is merely an example and any suitable algorithm may be used to generate the free space map. In some embodiments, the free space map may be generated to provide a minimum cardinality. In some embodiments, the techniques described in David Eppstein, “Graph-Theoretic Solutions to Computational Geometry Problems,” Computer Science Department, University of California, Irvine (Aug. 26, 2009) may be used to partition the free space of a world box into simpler geometric shapes.

A free space graph, can then be defined as the tuple (V,E), where V=FSM is the set of vertices (e.g., in the case of the “free space graph”, the set of “geometric elements”), and E, the set of edges, is a subset of V×V, with e in E is an edge between v1 and v2 in E if and only if v1 and v2 share a face. Hence, E is a subset of V×V, the cartesian product of the set of vertices with itself, and two geometric elements are neighboring (i.e., there exists an edge between the corresponding nodes) if they share a face.

Path planning can be computationally intensive. For example, an autonomous flying vehicle (e.g., drone 140) can travel through an infinite or uncountable number of different paths from a starting point to an ending point in a free space map. Accordingly, it is advantageous to constrain the problem to a small finite number of potential paths. One way is to impose a grid on the free space map. FIG. 4 shows an illustrative path planning grid 400 that is imposed on an environment having blocked spaces and/or obstacles 404. While grid 400 constrains the path planning problem to path segments between nodes 402, a fixed grid 400 may not provide a path planning solution because of how grid 400 may line up with blocked spaces and/or obstacles 404 and free space. For example, as illustrated in FIG. 4, blocked spaces and/or obstacles 404 are present in the middle horizontal portion of FIG. 2. Blocked spaces and/or obstacles 404 have an opening allowing a vehicle to travel between the upper and lower portions of FIG. 4. However, because of how grid 400 aligns with blocked spaces and/or obstacles 404, no path planning solution exists. While the size of the grid cells can be reduced such that a solution in FIG. 4 exists, the computational burden of path planning increases.

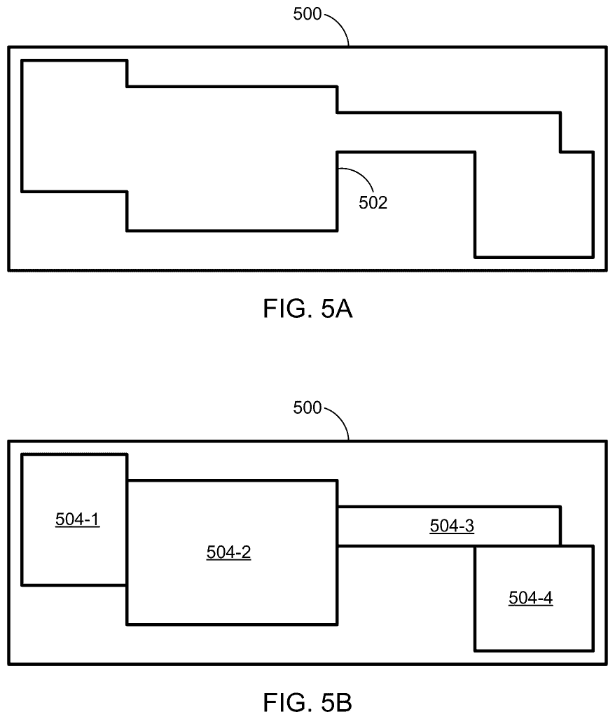

In accordance with the present disclosure, path planning (e.g., performed by path planner 128) is constrained in an intelligent way such that a path planning solution will be reliably found when a solution is possible and computational efficiency is achieved. FIG. 5A shows an illustrative two-dimensional world 500 defined by a free space boundary 502 to illustrate the path planning of the present disclosure. FIG. 5B shows a free space map 504 of the two-dimensional world of FIG. 5A. Free space map 504 comprises four geometric elements 504-1, 504-2, 504-3, and 504-4 (collectively referred to as free space map 504) in the shape of axis-aligned boxes. It will be understood that this is merely illustrative and any shaped world and number of free space geometric elements may be utilized in accordance with the present disclosure. It will be further understood that any M-dimensional worlds and geometric elements (e.g., three-dimensional worlds and three-dimensional boxes) in any shapes or forms may be utilized in accordance with the present disclosure, where M is an integer.

In accordance with the path planning of the present disclosure, jump surfaces are defined for each geometric element of free space map 504. As used herein, a jump surface refers to each surface investigated for a geometric element for determining if a path exists to one or more neighboring geometric elements. A boundary jump surface may be defined for each face of a geometric element in free space map 504. In some embodiments, each jump surface is inwardly offset from its respective face of the geometric element. In some embodiments, free space map 504 is generated inflating the blocked space and/or obstacles to account for a buffer and no offset is used. An offset and/or buffer ensures that a determined path will keep vehicles such as drones 140 at a sufficient distance away from a blocked space and/or obstacle. For example, a geometrical center of an autonomous vehicle may be used for path planning. However, an autonomous vehicle is not a singular point, but rather an object having a length, width, and height. Accordingly, the offset and/or buffer may be used to account for the size of the autonomous vehicle. In addition, an autonomous vehicle may be able to follow a path within a certain amount of accuracy (e.g., within 10 centimeters of the path due to accuracy of its positioning system and its maneuverability). Accordingly, the offset and/or buffer may also be used to provide a sufficient margin of error for the path following accuracy of the autonomous vehicle. The offset or buffer may be fixed or variable. Offsets may be dependent on the geometric element in free space map 504 (e.g., based on its size, shape, or location within a free space map) or any other criteria or metric. It will be understood that for two-dimensional environments, jump surfaces refer to lines. In some embodiments, for an N dimensional space, jump surfaces refer to N−1 dimensional hyperplanes, where N is an integer. For example, for a three-dimensional space, jump surfaces are two-dimensional surfaces.

In some embodiments, a boundary jump surface is considered by path planner 128 for each face of a geometric element in free space map 504. The boundary jump surface is a surface parallel to the considered face, possibly shifted inward by an offset+/−O. The boundary jump surface is propagated to a neighboring geometric element if it intersects the neighbor geometric element. A boundary jump surface is propagated as well to the neighbors of the neighbor recursively if it keeps intersecting them. In some embodiments, transition jump surfaces are considered by path planner 128 for a geometric element in free space map 504 sharing a surface with a neighbor geometric element if one or both of the boundary jump surfaces perpendicular to the common surface intersect the common surface. In this case, the transition jump surfaces are defined parallel to and on either side of the common surface (e.g., offset by O) and associated with their respective geometric elements sharing the common surface, unless a boundary jump surface already exists there for the neighboring geometric element. Multiple possible algorithms can be used to compute such boundary and transition jump surfaces.

While jump surfaces are described above as being defined and propagated to neighboring geometric elements, it will be understood that jump surfaces can also be referred to herein as jump planes that are associated with geometric elements. For example, a boundary jump plane may be defined for a geometric element (e.g., a plane parallel to and shifted inward from face of the geometric element) and intersections of the boundary jump plane with neighbor geometric elements can be evaluated iteratively until a neighbor geometric element is not intersected. When a boundary jump plane successfully intersects one or more neighboring geometric elements, the boundary jump plane is associated with the one or more neighboring geometric elements.

In some embodiments, the boundary jump surfaces and transition jump surfaces associated with each geometric element in free space map 504 are obtained with a breadth-first search as follows:

For all the geometric elements in free space map 504 b (to account for non-connected components of the free space graph), path planner 128 performs the following:
1. Initialize a set S (e.g., a queue) with an extraction rule (e.g., FIFO) as S={(b, { })}
2. While S is not empty, do the following:
   a. Extract one pair (b, J). J is a set of elements of the form (j, b′), where j is a surface, and b′ is the geometric element that started its propagation.
   b. If j intersects b, add j to the jump surfaces of b and of b′ (i.e., j is a boundary jump surface of b).
   c. For each of the neighbors b″ of b, add two surfaces (i.e., the transition jump surfaces) containing the shared surface shifted by +/−O to the jump surfaces of b.
   d. If b is visited for the first time, insert in S all the possible pairs (j, b″), where b″ is a neighbor of b and j is a surface defined by the surfaces of b, possibly shifted. Note that one can decide not to insert the pairs that will be discarded (for instance, if j does not intersect b″).
   e. Mark b as visited.

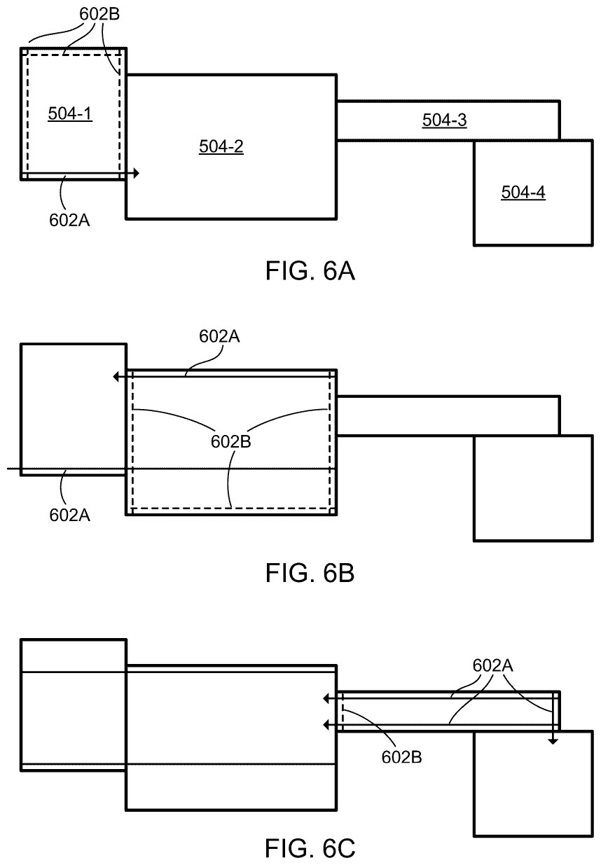

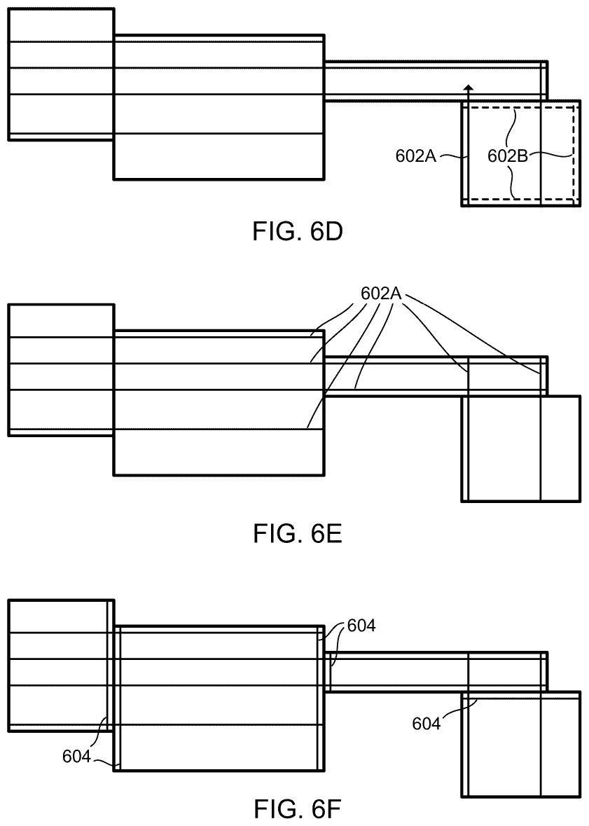

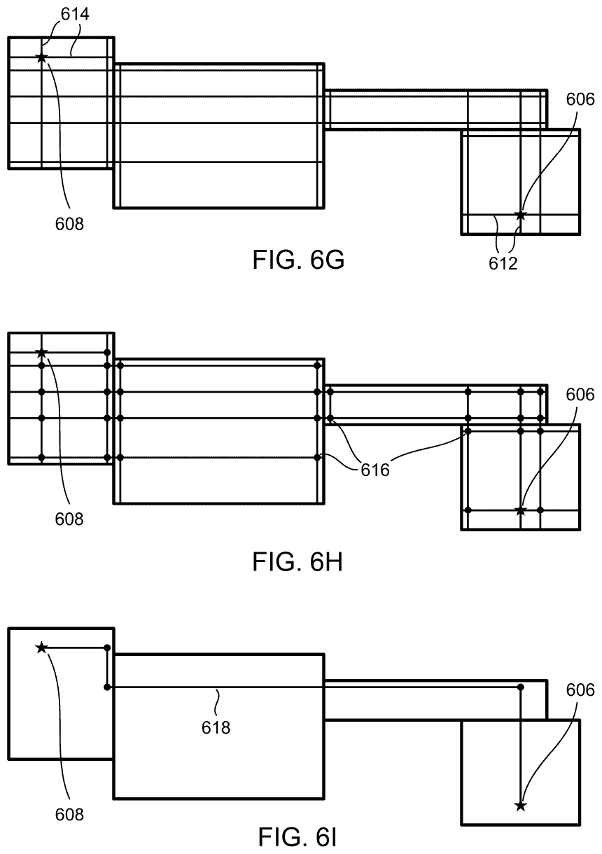

The techniques of the present disclosure will now be described in connection with the simple two-dimensional example of FIGS. 6A-I. FIG. 6A illustrates the four geometric elements that make up free space map 504 of FIG. 5B. Starting at geometric element 504-1 in FIG. 6A, path planner 128 defines four boundary jump surfaces 602, one for each face (i.e., in two-dimensions a side) of geometric element 504-1. As illustrated, each boundary jump surface 602 is inwardly offset from its corresponding face of the geometric element and is propagated outward. Three of boundary jump surfaces 602 do not intersect with any adjacent geometric element and are discarded. These boundary jump surfaces are illustrated as dashed lines and are labelled as boundary jump surfaces 602B. The remaining bottom boundary jump surface, labelled as boundary jump surface 602A, successfully propagates to a neighboring geometric element, in the direction pointed by the arrow. Boundary jump surface 602A is then propagated through geometric element 504-2, and it is recursively tested for intersection with neighbor geometric elements until there is no adjacent neighbor as shown in FIG. 6B.

The same or similar process is performed on geometric element 504-2. As shown in FIG. 6B, four boundary jump surfaces 602 are defined, where three are discarded (i.e., boundary jump surfaces 602B) and one successfully propagates to geometric element 504-1 (i.e., boundary jump surface 602A). Next, the process is performed on geometric element 504-3. As shown in FIG. 6C, four boundary jump surfaces 602 are defined, where one is discarded (i.e., boundary jump surface 602B) and three successfully propagate to adjacent geometric elements (i.e., boundary jump surfaces 602A). Two of the boundary jump surfaces 602A of geometric element 504-3 propagate through geometric elements 504-2 and 504-1 until there is no adjacent neighbor geometric element, as shown in FIG. 6D. Next, the process is performed on geometric element 504-4. As shown in FIG. 6D, four jump surfaces 602 are defined, where three are discarded (i.e., jump surfaces 602B) and one successfully propagates to neighbor geometric element 504-3 (i.e., jump surface 602A).

FIG. 6E shows all of the jump surfaces 602A that successfully propagated to neighboring geometric elements. As shown, at least two boundary jump surfaces 602A pass through every shared face between neighboring geometric elements 504-1 through 504-4. In some situations, not every shared face may have boundary jump surfaces that pass through. For example, if a geometric element is narrow, the boundary jump surface may be offset outside the geometric element. As a result, boundary jump surfaces may not be defined for the long sides of the narrow geometric element. In some embodiments, one or more rules may be applied or modified. For example, the free space map may be generated by free space map manager 124 with geometric elements whose sides satisfy a minimum length requirement (e.g., a minimum length greater than twice the offset). As another example, the jump surface offsets can be modified for narrow geometric elements to ensure at least one boundary jump surface intersects the narrow end, or a single jump surface may be defined along the middle of the narrow geometric element. Once boundary jump surfaces 602A are defined, two transition jump surfaces are then added to each shared face (e.g., each shared face intersected by at least one boundary jump surface). FIG. 6F shows all transition jump surfaces 604 that have been added to the shared faces in FIG. 6E. Transition jump surfaces 604 are added on both sides of the shared face (e.g., offset by the same amount as the jump surfaces). In some situations, a boundary jump surface may already exist where a transition jump surface is to be added. In these situations, only a single jump surface is added (e.g., at the shared face between geometric elements 504-3 and 504-4) or no transition jump surface when boundary jump surfaces already exist on both sides of the shared face. In some embodiments, transition jump surfaces 604 can be added first and then boundary jump surfaces can be added.

Additional jump surfaces can be added for a starting point (e.g., p1; i.e., a starting jump surface) and an ending point (e.g., p2; i.e., an ending jump surface) for a path. As illustrated in FIG. 6G, a starting point 606 for a vehicle is added to geometric element 504-4 and an ending point 608 for the vehicle is added to geometric element 504-1. Two starting jump surfaces 612 are added for the starting point and two ending jump surfaces 614 are added for the ending point. The starting jump surfaces are axis aligned surfaces containing the starting point, and the ending jump surfaces are axis aligned surfaces containing the ending point. Jump surfaces 612 and 614 are propagated until a free space boundary is reached. In some embodiments, the starting jump surfaces are not added. It will be understood that they are not necessary to plan a path. In some other embodiments, the starting jump surfaces are added and may be used together with cached paths.

The path planning technique shown in FIGS. 6A-G and described above reliably finds a path planning solution when one exists and reduces the computational load for finding a solution. It will be understood that for a three-dimensional space, additional jump surfaces will be added for each free space element. For example, for a free space element that is a three-dimensional box, six jump surfaces will be defined, one for each face of the box. In addition, three jump surfaces will be defined for each starting and ending point. It will also be understood that more or less jump surfaces may be used based on the shape of the element. For example, for two-dimensional triangular elements, three jump surfaces may be used.

The jump surfaces define a constrained number of potential paths for traveling from a starting point to an ending point. For example, the intersections of the surfaces define a set of nodes that can be explored for path planning by path planner 128. In some embodiments, when starting jump surfaces are not added to the path planning graph 130, the starting point may be added as a separate node, and jump surfaces are explored as described later. In some embodiments, the available paths between nodes lie on the jump surfaces. In some embodiments, a vehicle may be assumed to be able to move in any direction d in a set D, for example, along three orthogonal axes (x, y, z), but also other directions are possible. In some embodiments, within a single geometric element of the free space map 504, a path may be taken between any of the nodes. For example, diagonal paths may be available within a single geometric element (e.g., from a bottom left node to an upper right node), but horizontal and vertical paths are only available between different geometric elements. In some embodiments, diagonal paths may be taken between neighboring geometric elements, but only orthogonal paths may be taken within a geometric element. In some embodiments, diagonal paths may be taken within geometric elements and between neighboring geometric elements. The use of diagonal paths may result in shorter overall paths.

The following method may be used to define the set of nodes to be explored for path planning:
1. Let JS=Jump Surfaces, which is the set of successfully defined jump surfaces.
2. Let V be the set of nodes to explore, V′ an auxiliary set.
3. Initialize V={ }, V′={p}, where p may be the starting point p1.
4. While V′ is not empty, perform the following:
   a. Take any p from V′, V′=V′\{p}.
   b. Get the jump surfaces of the free space box containing p.
   c. For all d in D, consider the line 1 starting at p and with direction d. If 1 intersects a jump surface, take the point p′ originating from the first intersection.
   d. For all the obtained points p′, if (p,p′) is in line of sight (there is no blocked space and no obstacle in between) and p′ is not in V, put p′ in V′: V′=V′ U {p′}.
   e. Add p to V.
      It will be understood that, with the above method, starting jump surfaces are not needed to plan a path between p1 and p2. In some embodiments, starting jump surfaces may be used along with cached paths. It will also be understood that, as long as D contains the axis directions as well, p2 will be included in V at the end of the above-described method.

The foregoing is merely an example of how to generate a set of nodes to explore from a point p. By using the free space map and techniques of the present disclosure, path planning is efficiently performed because checking whether no blocked space and no obstacle occludes the path between a point and its neighbors on a jump surface requires only a small number of checks in the free space map (only the current and adjacent geometric elements), in contrast to using a container of the blocked spaces and/or obstacles. Indeed, the free space graph allows one to readily recover the geometric elements adjacent to the one currently explored (e.g., at step 4.d above). In some embodiments, occlusion checks can be avoided if two points within the same geometric element are connected by an axis aligned segment, because no blocked spaces and no obstacles will be present. In some embodiments, other methods may be used to generate an equivalent set of nodes. The set of nodes may be generated in real-time based on received starting and/or ending points or they may be predetermined based on a range of starting and ending points.

FIG. 6H shows a set of nodes 616 determined based on boundary jump surfaces 602A and transition jump surfaces 604 determined from geometric elements 504-1 through 504-4 and jump surfaces 612 and 614 determined from starting point 606 and ending point 608. A node 616 is added to each intersection of surfaces 602A, 604, 612, and 614. Nodes 616 represent a constrained number of potential paths from starting point 606 to and ending point 608. Once nodes 616 are determined, any algorithm may be used by path planner 128 to determine a preferred or optimal path from starting point 606 to the ending point 608. FIG. 6I illustrates an illustrative path 618 from starting point 606 to ending point 608. Path 618 comprises 4 straight segments that pass through three of nodes 616. In some embodiments, the set of nodes may not be determined prior to the optimization, but generated during the optimization. For instance, a shortest path algorithm such as A* or Dijkstra may be used, and only the neighbors of the explored point p may be computed, according to steps 4.a-e above.

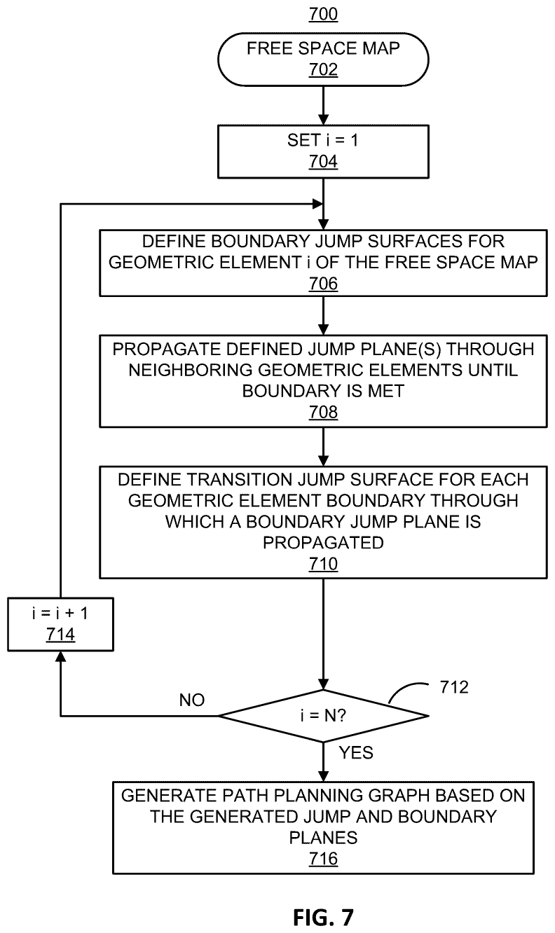

FIG. 7 is a flowchart of an illustrative process 700 for generating a path planning graph, in accordance with some embodiments of the present disclosure. Process 700 may be executed at least in part by processing circuitry 134, 114, or 214 or a combination thereof. In some embodiments, process 700 is executed by processing circuitry implementing path planner 128.

At 702, processing circuitry accesses a free space map. In some embodiments, path planner 128 accesses a free space map maintained by free space map manager 124. The free space map comprises an N number of geometric elements, where N is an integer. The geometric elements may be M dimensional (e.g., two- or three-dimensional) and may be any suitable geometric shapes, where M is an integer. For example, the geometric elements may be rectangular, triangular, hexagonal, any other shape, or any combination thereof. The free space map may be represented in any suitable format. For example, for a two-dimensional free space map comprising geometrical elements in the shape of boxes (i.e., rectangles), the locations of two opposite corners of each box may be stored in the two-dimensional free space map. As another example, for a three-dimensional free space map comprising geometrical elements in the shape of boxes, the locations of two opposite corners of one face of the box and the location of one corner on an opposite face of the box may be stored in the three-dimensional free space map for each box. The data for each box may be stored using different data structure (e.g., Bounding Volume Hierarchy, Kd-Trees, Quad-Tree, etc.). In some embodiments, the free space map may comprise a label (e.g., number) for each geometrical element and further comprise information indicating which geometric elements that are adjacent to each geometric element (i.e., neighboring elements). In some embodiments, the free space map may further comprise the shared edges between adjacent geometric elements. In some embodiments, the free space graph may not be stored and the neighbor geometric elements may be computed when needed. However, this may increase the computational complexity of the method.

At 704, the processing circuitry sets counter i equal to one. The counter is used to iterate through each of the N number of geometric elements at 706-710.

At 706, the processing circuitry defines boundary jump surfaces for geometric element i of the free space map. In some embodiments, the boundary jump surfaces are defined as described above in connection with each of FIGS. 6A-D. For example, a boundary jump surface may be defined for each face of geometric element i. The boundary jump surfaces may be inwardly offset from their respective faces. In some situations, a boundary jump surface may already exist for a face of a geometric element because it was propagated from a neighboring geometric element. When a jump surface already exists for a side, a new boundary jump surface is not defined for that face. In some embodiments, at least one duplicated boundary jump surface may be defined and not discarded. The resulting free space graph is equivalent, albeit the construction and use may be less efficient.

At 708, the processing circuitry propagates the defined boundary jump surfaces through neighboring geometric elements until a blocked space and/or an obstacle is met. In some embodiments, the boundary jump surfaces are propagated as described above in connection with each of FIGS. 6A-D. Depending on the shape of the free space, a boundary jump surface may not be propagated (e.g., where the boundary jump surface does not intersect a neighboring geometric element) or it may be propagated though one, two, three, or more neighboring geometric elements. In some embodiments, at 708, the defined boundary jump surfaces that are not propagated are discarded.

At 710, the processing circuitry defines a transition jump surface for each boundary of a geometric element through which a jump surface is propagated. In some embodiments, the transition jump surfaces are defined as described above in connection with FIG. 6F. For example, the processing circuitry may define two transition jump surfaces for each boundary of a geometric element through which a boundary jump surface is propagated, each on opposite sides of the shared face and offset from the shared face. In some situations, a jump surface may already exist for a shared face boundary. When a jump surface already exists for a boundary, a new transition jump surface is not defined for that side of the boundary.

At 712, the processing circuitry determines whether the counter i is equal to N, the number of geometric elements of the free space map. If it is determined that the counter is not equal to N (i.e., No at 712), process 700 proceeds to 714, where the counter i is incremented and steps 706-710 are repeated for the next geometric element of the free space map. If it is determined that the counter is equal to N (i.e., Yes at 712), process 700 proceeds to 716.

At 716, the processing circuitry generates a path planning graph based on the defined jump surfaces. In some embodiments, the path planning graph is generated as described above in connection with FIGS. 6G-H. In some embodiments, the intersections of the surfaces are used to define a set of nodes as part of the path planning graph. In some embodiments, the surfaces are used to define a reduced set of potential paths that can be used for navigating through the free space environment as part of the path planning graph. In some embodiments, the path planning graph is additionally based on jump surfaces determined based on starting and ending points of a path. The path planning graph may be generated and stored in any suitable format of structured data for storing the information. For example, in some embodiments, the path planning graph comprises the locations of the nodes (e.g., [x,y] or [x,y,z]). In some embodiments, the path planning graph additionally or alternatively comprises the jump surfaces. In some embodiments, the path planning graph additionally comprises distances between nodes. In some embodiments, the path planning graph additionally comprises travel time or speed of travel between nodes.

It will be understood that various modification may be made to process 700 in accordance with the present disclosure. For example, step 710 may be performed for all of the boundaries through which a boundary jump surface is propagated after Yes is determined at 712. As another example for a narrow geometric element, a single jump surface, centered between the long sides of the geometric element, may be defined at 706 instead of two boundary jump surfaces, one for each long side.

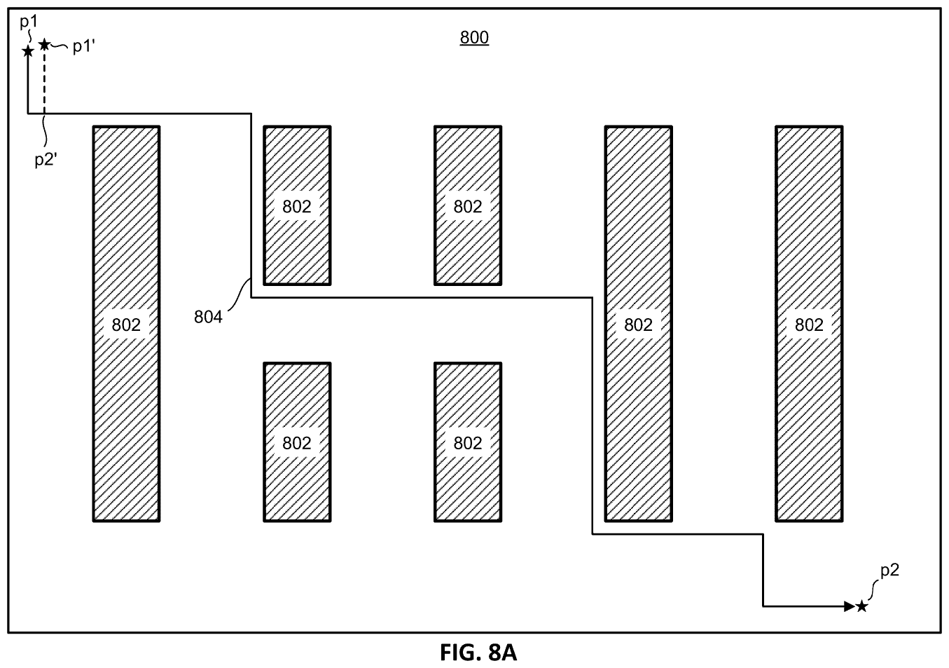

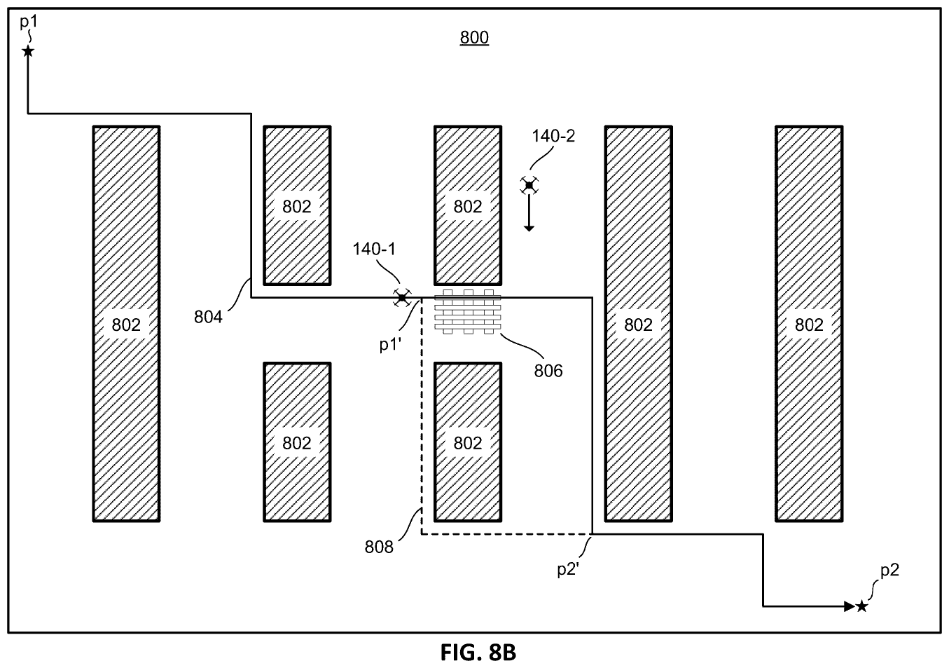

As explained above, one or more paths may be determined using a path planning graph generated in accordance with the present disclosure. In some embodiments, determined paths can be stored and reused for future path planning. FIG. 8A shows two paths to an ending point p2 in a warehouse environment 800, in accordance with some embodiments of this disclosure. Warehouse environment 800 is merely illustrative and can correspond to any other type of facility or environment. Warehouse environment 800 includes a plurality of blocked spaces and/or obstacles 802, which may correspond to rows of storage racks. However, blocked spaces and/or obstacles 802 may correspond to any structure or objects that block the path of a drone or other autonomous vehicle.

Warehouse environment 800 shows a determined path 804 starting at p1 and ending at p2. Path 804 may be referred to as (p1, p2). In some embodiments, path 804 is determined based on the methods and techniques described above (e.g., using a path planning graph such as path planning graph 130). Path 804 may be stored (e.g., in cached paths 132) and reused in connection with subsequent path planning. For example, when path planner 128 is determining a new path starting at point p1′ to the same ending point p2, points in the cached path 804 can be considered as possible ending points p2′, such that the portion of the cached path from p2′ to p2 can be reused. As illustrated in FIG. 8A, path planner 128 determines a single path segment from p1′ to point p2′ on cached path 804. This path segment (p1′, p2′) is then joined with the cached path 804 from p2′ to p2. Accordingly, the resulting path is the union of the path from p1′ to p2′ and the cached path from p2′ to p2.

The use of cached paths provides additional computational efficiency. In some embodiments, the determination of the path p1′ to p2′ on cached path 804 uses the method and techniques described above. For example, starting jump surfaces may be defined for starting point p1′ as described above (e.g., similar to how jump surfaces 612 were defined for starting point 606). Then, cached paths 132 may be evaluated to identify cached paths that start or end at p2. The defined jump surfaces for p1′ are evaluated to determine if any of the jump surfaces intersect any of the identified cached paths. If so, the intersection can be defined as p2′ and the portion of the cached path from p2′ to p2 can be reused. If no jump surfaces for p1′ intersect any of the identified cached paths, the previously determined jump surfaces can be evaluated to determine if any of them intersect with the jump surfaces for p1′. If so, these jump surfaces can also be evaluated to determine if any of them intersect with any of the identified cached paths. This process can be repeated until an intersection with a cached path is found, until a number of attempts is reached, until p2 is reached, or until any other criteria is satisfied.

In some situations (e.g., in warehouse environment 800), the starting points for drones 140 may be the same or only slightly different than other previous starting points. For example, drones 140 may all be stored on separate charging stations in close proximity to each other. In such situations, one starting point p1 (e.g., located in a geometric center of the charging stations for drones 140) can be considered fixed and the resulting path planning graph can be considered as static for all the path planning. Caching in such situations can then be exploited intensively. For example, path planner 128 may evaluate each path segment and assign a corresponding cost that is used when performing path planning. In one example, the cost of often used paths can be decreased (e.g., when the often used path is successfully navigated). In addition, nodes that have a small cost (e.g., because they are used often) can be directly connected because they are expected to very rarely have obstacles between them.

It will be understood that any combinatorial optimization algorithm can be used by path planner 128 to find an optimal path between p1 and p2, passing through the nodes defined above. In a first example, A* or any other graph based shortest path algorithms may be used, starting from p1, and for any current node the neighbors as described above may be considered. In a second example, rapidly exploring random tree (RRT)/RRT*/and related sampling from the set of nodes V may be used. In a third example, potential fields methods to define a heuristic for a greedy search in the nodes V may be used. That is, start from p 1 and move to the neighbors that minimize the potential fields, and repeat until one possibly reaches p2. In a fourth example, genetic algorithms are used where mutations and paths are always supported by the set of nodes V.

One or more additional post-optimizations may be used by path planner 128, depending on the motions available to a vehicle. In some embodiments, one can introduce a fixed or variable number of points on each path segment (i.e., upsample the resulting path), and perform an optimization algorithm that minimizes the total cost of the path, defined as the sum over the points pi in the path of some cost c (pi, pi+1); i.e., the cost to go from pi to pi+1. Different strategies may be used to decide which points to introduce and how many. For example, the number may be constant and the points equally spaced on the path segment. As another example, the number may be variable and depend on the geometric elements containing the path segment. In some embodiments, the above refinement can be done using dynamic programming. In some other embodiments, the same above refinements can be performed with any other combinatorial optimization strategy, not necessarily yielding an improvement. For example, one could use a greedy approach. In some embodiments, when looking for a path from p1 to p2, one can define a visibility set G, such that for all p2′ in G, (p2′, p2) are in line of sight and there exists a direction d in a set of directions D′ possibly different from D such that (p2′, p2) is a vector aligned with d, then a combinatorial optimization algorithm can stop as soon as it reaches any point in G, and p2′ is connected to p2 along d. For example, one may use the methods described in the present disclosure to refine the path, possibly with a path planning graph generated with a set of directions D″ possibly different from D′ and D.

The foregoing method and techniques can also be utilized for real-time replanning when a vehicle such as a drone 140 encounters an obstacle. FIG. 8B shows a path obstacle 806 and an alternate path 808 in warehouse environment 800 of FIG. 8A, in accordance with some embodiments of this disclosure. As shown, drone 140-1 (e.g., an aerial vehicle) is navigating along path 804 from starting point p1 to ending point p2. As described above, drone 140-1 may receive and store path planning graph 130 (e.g., a set of nodes V), cached paths 132, and a free space map. In some embodiments, drone 140-1 may construct the path planning graph given the free space map onboard. When drone 140-1 encounters obstacle 806 while navigating along path 804, drone 140-1 may use its current position as a p1′ point and use the techniques described above to find an alternate path 808 to a subsequent point p2′ on path 804 (or another cached path to p2). In some embodiments, drone 140-1 may identify the geometric element in the free space map containing the obstacle as not being available or free. Drone 140-1 may also identify the jump surfaces associated with the identified geometric element, and their corresponding nodes V as not being available. In some embodiments, any cached paths passing through the identified geometric element may also be identified as not being available. In some embodiments, a cached path is composed of points p1, p2, . . . , pN and the points blocked are a set BP={pi}, where k is the maximum i among the indices of the points in BP. Thus, the remaining sub path of pk+1, . . . , pN may be retained as being available as opposed to identifying the entire path as being unavailable. Drone 140-1 may store the information related to this obstacle locally as well as report this information back to drone management system 120 so that the free space map manager 124, obstacle manager 126 and path planner 128 can update their information accordingly. This enables path planner 128 to avoid obstacle 806 when determining future paths. In some embodiments, drone management system 120 transmits the obstacle related information to other ones of drones 140 for their use in path planning and replanning.

In some embodiments, the size of an obstacle, such as obstacle 806, is determined and only a portion of its corresponding geometric element is indicated as being unavailable. In some embodiments, a predetermined size is assigned to every obstacle (e.g., based on the size of obstacles expected in an environment). In some embodiments, free space map manager 124 generates updated geometric elements around the obstacle, which are used to determine updated jump surfaces, and nodes. For example, the geometric element containing the obstacle can be divided into two or more geometric sub-elements, where at least one geometric sub-element corresponds to free space and at least one other geometric sub-element corresponds to obstructed space. In some embodiments, an obstacle may be considered to be only temporary and obstacle manager 126 may set a timer when the obstacle is encountered. Once the timer expires, the corresponding geometric element is indicated as being available and the jump surfaces, nodes, and cached paths are accordingly updated (e.g., the previously determined geometric elements, jump surfaces, and nodes are restored, and cached paths marked as unavailable are marked as available again).

In some embodiments, as shown in FIG. 8B, a second drone 140-2 may be passing near the location of obstacle 806. Drone 140-2 may include sensors 210 (e.g., a camera, Lidar, etc.) and sensors 210 may be used to determine if obstacle 806 is still there. For example, path planner 128 may transmit a determined path and obstacles near the determined path to drone 140-2. As drone 140-2 navigates along its path, drone 140-2 can use its sensors to determine whether the nearby obstacles are still present. If an obstacle such as obstacle 806 is no longer detected, drone 140-2 may transmit this information to drone management system 120, which may in turn use this information to restore the previous path planning settings (e.g., available cached paths 132, path planning graph 130, etc.). In some embodiments, drone 140-2 may store the information about the obstacle and transmit it to drone management system 120 at a later time. For example, when drone 140-2 has returned to a charging station. In some other embodiments, drone 140-2 may not transmit this information to drone management system 120.

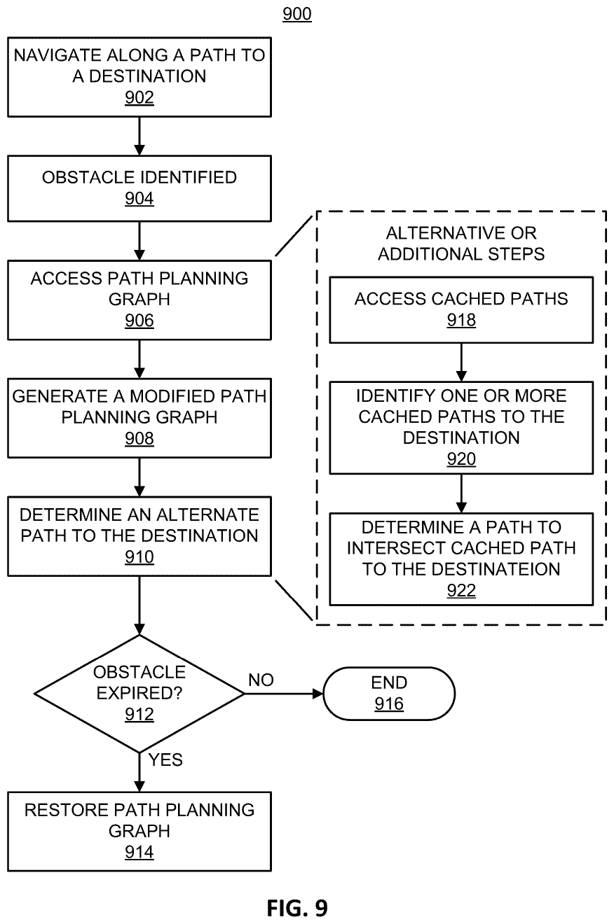

FIG. 9 is a flowchart of an illustrative process 900 for performing path replanning during navigation when an obstacle is identified, in accordance with some embodiments of the disclosure. Process 900 may be executed at least in part by processing circuitry 134, 114, or 214 or a combination thereof. In some embodiments, process 700 is executed by drones 140, such as drone 140-1 of FIG. 8B.

At 902, an autonomous vehicle (e.g., drone 140-1) navigates along a path to a destination. In an illustrative example, drone 140-1 of FIG. 8B is navigating along path 804 from starting point p1 to ending point p2. Drone 140-1 includes a localization sensor for determining its position within warehouse environment 800. Drone 140-1 can compare its position to path 804 and generate a control signal to be applied to an actuator to affect control of the motion of drone 140-1. For example, drone 140-1 may include four actuators 202 (e.g., four motors) and drone 140-1 may generate four control signals to be respectively applied to the four actuators to control the motion of drone 140-1 to follow path 804.

At 904, an obstacle is identified. For example, the obstacle may obstruct the path of drone 140-1 from following path 804. The obstacle may be identified using one or more sensors of drone 140-1. For example, a forward ultrasonic sensor, LiDAR sensor, or IR sensor may generate a signal that identifies an object in front of drone 140-1 in a position that obstructs its path. As another example, an image sensor may capture images of the environment in front of drone 140-1. The sensor signals and/or images may be processed by processing circuitry to identify the presence of obstacles. In some embodiments, only some dimensions of the obstacle may be determined. For example, based on the sensor data, the height and/or width of the obstacle may be determined (e.g., based on a distance to the obstacle and based on the number of pixels in an image that the obstacle takes up). In some situations, the depth of the obstacle may be predetermined (e.g., all obstacles are assigned the same depth or the type of obstacle is identified and a predetermined depth is assigned based on the type of obstacle). In some situations, the actual obstacle size may be larger than one or more dimensions assigned to the obstacle. For example, two obstacles maybe adjacent to each other and an assigned dimensions are for only a single obstacle. In this situation, the larger obstacle or combined obstacles may be encountered again and the assigned dimensions can be updated or refined. In some situations, certain dimensions may be chosen for safety based on the sensor setup of drone 140-1. For example, if drone 140-1 does not have sensors on top, flying below an obstacle may not allow drone 140-1 to gain height safely as the sensor setup may not be able to identify the end of the obstacle. When a lifted obstacle (i.e., not touching the ground) of unknown depth is encountered, the bounding volume may be extended to reach the ground. In this case, the replanned path will not pass below the obstacle. Drone 140-1 may also set a timer corresponding to the identified obstacle and may report the location of the identified obstacle to drone management system 120.

Once an obstacle is identified at 904, process 900 may proceed to 906, 918, or to both to replan a path to the destination. At 906, the autonomous vehicle accesses a path planning graph. For example, drone 140-1 may access path planning graph 130, which is stored locally in memory.

At 908, the autonomous vehicle generates a modified path planning graph. For example, drone 140-1 may use the location of the identified obstacle to identify one or more of boundary jump surfaces, transition jump surfaces, and corresponding nodes as not being available. As another example, drone 140-1 may use the location of the identified obstacle to replace one or more of boundary jump surfaces or transition jump surfaces with one or more shortened surfaces that exclude the portion of the one or more surfaces that correspond to the obstacle. As yet another example, drone 140-1 may use the location of the identified obstacle to remove a segment of jump surfaces that passes through the obstacle. As yet another example, drone 140-1 may identify the geometric element corresponding to the location of the obstacle as not being available. As yet another example, drone 140-1 may determine the size of the obstacle and divide the geometric elements in which the obstacle is located into sub-elements, where one or more sub-elements correspond to the obstacle and are therefore blocked and another one or more sub-elements correspond to free space and are available. In some embodiments, drone 140-1 may use process 700 for the affected portions of the accessed path planning graph to define new boundary jump surfaces, transition jump surfaces, and nodes to generate a modified path planning graph that takes into account the identified obstacle.

At 910, the autonomous vehicle determines an alternate path to the destination based on the modified path planning graph. For example, drone 140-1 may include its own path planner corresponding to path planner 128 of drone management system 120. Drone 140-1's path planner may use its current position as p1′ and determine an alternate path from p1′ to its destination based on the modified path planning graph. For example, as shown in FIG. 8B, drone 140-1 determines alternate path 808 from p1′ to p2′ and reuses the remaining portion of the path 804 from p2′ to reach the destination p2. As another example, drone 140-1 may determine an alternate path to its destination that does not reuse the original path. In view of the foregoing, steps 906-910 show one process for performing path replanning. Steps 918-922 perform an alternative or additional process for performing path replanning.

At 918, the autonomous vehicle accesses cached paths. For example, drone 140-1 may have received and stored cached paths 132 from drone management system 120. Drone 140-1 may then access the cached paths by retrieving or searching for information within the stored cached paths. As another example, drone 140-1 may access the cached paths by requesting the cached paths from drone management system 120.

At 920, the autonomous vehicle identifies one or more cached paths that lead to the destination. For example, drone 140-1 may search the cached paths to identify a subset of paths that have the same destination as drone 140-1. Drone 140-1 may additionally or alternatively search the cached paths to identify a subset of paths that have drone 140-1's destination as part of the paths. In some embodiments, cached paths may not end at the destination and/or may not include the destination as part of the cached paths. In this case, a cached path or a portion of a cached path may be considered as an additional connection or path between nodes of the path planning graph. The autonomous vehicle may consider these cached paths or portions of paths when determining an optimal path to the destination.

At 922, the autonomous vehicle determines a path to intersect a cached path to the destination. For example, drone 140-1 explores one or more nodes based on its current location (e.g., similar to how the set of nodes of the path planning graph was generated). Drone 140-1 may then evaluate whether the explored nodes belong to any of the identified cached paths to the destination. If so, the node can be defined as p2′ and the portion of the cached path from p2′ to the destination can be reused. If no node belongs to any of the identified cached paths, the other nodes can be explored from the first set of nodes. These new nodes can also be evaluated to determine if any of them belong to any of the identified cached paths. This process can be repeated until a node belonging to a cached path is found or until no solution is found (e.g., after a number of attempts has been performed). In some embodiments, cached paths or portions of cached paths may considered for determining a path that intersects with another cached path that reaches the destination.

In some situations two or more alternate paths may be determined from the autonomous vehicle's current position to the destination (e.g., one or more paths determined at 910 and one or more paths determined at 922). In some embodiments, 910 and 922 are performed in parallel and process 900 stops once a first alternative path is determined. In some embodiments, 910 and 922 are performed in parallel and continue until multiple alternative paths are determined. When multiple alternative paths are available, the autonomous vehicle may select the shortest alternative path or the alternative path having the lowest cost associated with it as described in more detail below. The autonomous vehicle may then use the determined or selected alternative path to continue navigating to its destination.

In some embodiments, process 900 continues to 912, where it is determined whether the obstacle expired. As explained above, drone 140-1 may set a timer corresponding to the identified obstacle. In some environments, obstacles are likely to move after a certain amount of time. For example, in a warehouse environment a forklift obstacle is not expected to stay in one location for more than 15 or 30 minutes. Accordingly, when a forklift obstacle is identified, a timer may be set for 30 minutes. As another example, as autonomous vehicles navigate through an environment, they may use their sensors to determine if previously identified obstacles are still present. If the obstacle is not expired (e.g., a timer has not expired and/or an autonomous vehicle has not reported that the obstacle is no longer present), process 900 may proceed to 916 and end or process 900 may start over.

If the obstacle is expired (e.g., a timer has expired and/or an autonomous vehicle has reported that the obstacle is no longer present), process 900 may proceed to 914 and restore the previous path planning graph.

It will be understood that various modification may be made to process 900 in accordance with the present disclosure. For example, steps 912-916 may be omitted. As another example, steps 906-910 or steps 918-922 may be omitted. As yet another example, steps 918-922 may be performed first and only if an alternate path cannot be found, then steps 906-910 are performed. As yet another example, in some embodiments, steps 904, 906, 908, 921, and 914 are used for generating a modified path planning graph based on an identified obstacle and then restoring the path planning graph in response to the obstacle expiring.

The use of path planning graphs generated in accordance with the present disclosure, along with, for example, process 900, enables autonomous vehicles to perform path replanning in real-time because of the computational efficiencies of the present disclosure and, for example, sufficiently guarantees that a new path planning solution will be found when possible.

As described above, some environments include blocked spaces and obstacles such as warehouse environments. In such environments, obstacles may be more likely to obstruct some geometric elements more than other elements. Accordingly, reuse of a cached path may decrease the likelihood that the path will be obstructed. In addition, when cost-based algorithms are used (e.g., by path planner 128), the cost associated with successfully traveled path segments may be reduced the more often the path segments are successfully traveled. In some embodiments, a path planning graph is determined for a warehouse environment based on locations of blocked spaces (e.g., walls, shelves, etc.). As paths are planned, navigated, and obstacles are identified, the path planning may be modified as discussed above to account for real-time changes in the environment. In some embodiments, the path planner may revert back to or restore the original path planning graph periodically or when one or more criteria are met. For example, the path planner may revert back to the original path planning graph once a day or after a predetermined number of modifications are performed. This may beneficial when information is known about how or when the environment changes. For example, different deliveries and shipments may be scheduled on different days of the week and different areas of the warehouse may be obstructed based on the particular delivery or shipment. As an illustrative example, a first area of a warehouse may include multiple obstructions on Mondays, but that area is typically obstruction-free Tuesday mornings. If a modified path planning graph from Monday is used for Tuesday morning, the available path segments or nodes in the first area may be limited and it may take time before drones 140 identify that the obstacles are no longer present. However, by resetting the path planning graph on Tuesday mornings based on the blocked spaces, path planning will be optimized more quickly in the first area. Accordingly, when information is known about how or when conditions typically change, the path planning graph can be modified to account for these changes.

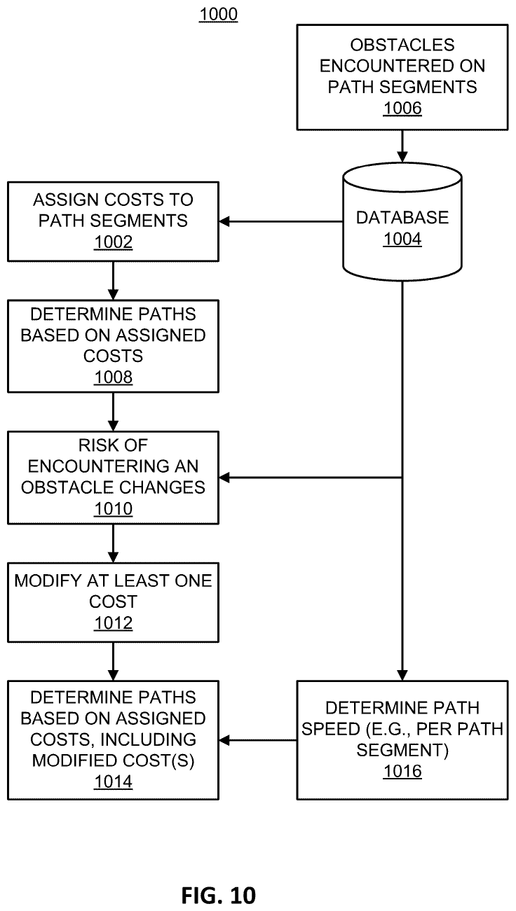

FIG. 10 is a flowchart of an illustrative process 1000 for performing path planning based on assigned costs, in accordance with some embodiments of the disclosure. Process 1000 may be executed at least in part by processing circuitry 134, 114, or 214 or a combination thereof. In some embodiments, process 1000 is executed by processing circuitry implementing path planner 128 or by drones 140.

At 1002, path planner 128 (e.g., as implemented by processing circuitry 134) assigns costs to path segments. In some embodiments, path planner 128 assigns costs based on data stored in database 1004. The data may indicate the risk of encountering an obstacle on the path segments. Database 1004 may be maintained, for example, by path planner 128 or obstacle manager 126 based on obstacles encountered on path segments (e.g., obtained at 1006). Database 1004 may store a history of determined paths and information associated with the navigation of the determined paths. In some embodiments, database 1004 may store the historical information for individual path segments. Database 1004 may store the time when each path segment or path was navigated and whether any obstacles were encountered. Database 1004 may store statistical information based on each path segment. The statistical information may be for a single time scale or for a range of different time scales (e.g., the past 30 minutes, the past 1 hour, the past 2 hours, the past 6 hours, the past 12 hours, the past day, the past month, etc.). In one example, path planner 128 assigns costs based on a ratio of the number of times an obstacle was encountered on a path segment over the total number of times the path segment was navigated. The ratio, or a number derived from the ratio, may correspond to a level of risk of encountering an obstacle on the path segment. In some embodiments, other methods may be used to estimate such a level of risk. In some embodiments, path planner 128 assigns costs based on the historical data and the path segment length. For example, the assigned cost may be based on a summation or multiplication of the path segment length and the historical data indicating a risk of encountering an obstacle on the path segment. Database 1004 may also store data indicating expected activity levels in different areas within the free space map and path planner 128 may use the expected activity levels when assigning costs. For example, costs for path segments in areas of a warehouse where activity levels are expected to be high may be increased and costs for path segments in areas of the warehouse where activity levels are expected to be low may be decreased.

At 1008, path planner 128 determines paths based on the assigned costs. For example, depending on the environment, path planner 128 may determine multiple different paths from a starting point to an ending point using the methods and techniques described above. When multiple different paths are found, path planner 128 may determine the total cost of each determined path and select the path having the lowest cost to be used for navigation. Path planner 128 may continue to determine paths for drones 140 based on the assigned costs until the risk of encountering an obstacle changes.

At 1010, path planner 128 determines the risk of encountering an obstacle has changed. In some embodiments, path planner 128 periodically (e.g., every minute, every five minutes, every 10 minutes, etc.) checks database 1004 to see if the data indicating risk has changed. In some embodiments, database 1004 sends a message to path planner 128 when data indicating risk changes.

At 1011, path planner 128 modifies at least one assigned cost. For example, path planner 128 may access database 1004 and determine which path segments have new or changed data. For the path segments having new or changed data, path planner 128 may modify the previously assigned cost by determining a new cost and replacing the previously assigned cost with the new cost. In some embodiments, path planner 128 modifies the at least one cost by determining new costs for all of the path segments.

At 1014, path planner 128 determines paths based on the assigned costs, including the at least one modified cost. As explained above, path planner 128 may determine multiple different paths from a starting point p1 to an ending point p2 using the methods and techniques described above. When multiple different paths are found, path planner 128 may determine the total cost of each determined path and select the path having the lowest cost to be used for navigation. As costs change, the total costs of some paths may increase whereas the total costs for other paths may stay the same or decrease. What this means is that a first path may be selected as having the lowest cost for path (p1, p2) at 1008 and a second different path may be selected as having the lowest cost for path (p1, p2) at 1014. In some situations, the first path may be the shortest path (i.e., shortest total length of all of its segments). However, because of obstacles encountered along one or more path segments of the first path, the second path may be selected at 1014 even though it is a longer path.

In some embodiments, at 1016, path planner 128 determines path speed. For example, path planner 128 may determine a speed for each path segment based on the historical data indicating the risk of encountering an obstacle. In some embodiments, path segments having a lower risk of encountering an obstacle may be assigned a higher path speed than path segments having a higher risk of encountering an obstacle. In some embodiments, the path speed is only used by autonomous vehicles to control the speed of the autonomous vehicles along the determined paths. In some embodiments, the path speed is used by path planner 128 for path planning. For example, the cost assigned to each path segment may be additionally or alternatively determined based on path speed. In one example, path segments having higher path speeds may be assigned a lower cost than path segments having lower path speed.

It will be understood that various modification may be made to process 1000 in accordance with the present disclosure. For example, the path speeds of 1016 may also be used by path planner 128 at 1008. As another example, step 1016 may be omitted and the paths are not assigned speeds.

In view of the foregoing, the methods of the present disclosure may be performed by processing circuitry 134 of drone management system 120, processing circuitry of the autonomous vehicles (e.g., drone 140), or a combination thereof. For example, processing circuitry 134 of drone management system 120 may determine and maintain the path planning graph, store successfully navigated paths, determine paths for pairs of points (e.g., (p1, p2)), and transmit paths to relevant autonomous vehicles to follow. The autonomous vehicles may receive paths for navigating from a current point p1 to a desired point p2. In another example, drone management system 120 may determine a collection of points P2={p21, p22, . . . , p2M} to be reached by an autonomous vehicle (e.g., drone 140). Processing circuitry of the autonomous vehicle may receive the collection of points P2 and compute paths (p1, p21), (p21, p22), . . . , (p2M−1, p2M) to follow sequentially, where p1 is the current location of the autonomous vehicle. The autonomous vehicles, during navigation of paths, may identify obstacles and perform real-time path replanning based on locally stored copies of the free space map, the path planning graph, and/or cached paths in a computationally efficient manner as described above.

It will be understood that the path planning graph (e.g., a set of nodes or available path segments) generated in accordance with the teachings of the present disclosure provides an optimized reduced set of potential paths. Such an optimized path planning graph will improve any existing or future path planning algorithms by reducing the complexity of the path planning problem, which in turn reduces the computational load for determining a path planning solution. For example, the path planning graph of the present disclosure can be used with evolutionary algorithms, shortest path algorithms, and combinatorial optimization algorithms.

The present disclosure may be practiced as a method or device adapted to practice the method. It is understood that the examples in this application are intended in an illustrative rather than in a limiting sense. In accordance with the present disclosure, limitations of current path planning systems have been reduced or eliminated. While certain aspects of the present disclosure have been particularly shown and described with reference to exemplary embodiments thereof, it will be understood by those of ordinary skill in the art that various changes in form and details may be made therein without departing from the spirit and scope of the present disclosure as defined by the following claims. It will also be understood that the components of the present disclosure may comprise hardware components or a combination of hardware and software components. The hardware components may comprise any suitable tangible components that are structured or arranged to operate as described herein. Some of the hardware components may comprise processing circuitry (e.g., a processor or a group of processors) to perform the operations described herein. The software components may comprise code recorded on tangible computer-readable medium such as memory. The processing circuitry may be configured by the software components to perform the described operations. It is therefore desired that the present embodiments be considered in all respects as illustrative and not restrictive.

1.-20. (canceled)

21. A method comprising:
assigning costs to a plurality of available path segments based on data indicating risk of encountering obstacles; and
determining a path from a starting point to an ending point based on the assigned costs.

22. The method of claim 21, further comprising modifying at least one cost corresponding to at least one path segment of the available path segments based on data indicating a change in risk of encountering an obstacle on the at least one path segment.

23. The method of claim 22, wherein modifying the at least one cost corresponding to the at least one path segment comprises:
decreasing the cost of a first path segment based on historical data indicating a low risk of encountering an obstacle on the first path segment, wherein a decreased cost corresponds to an increased path speed for the first path segment; or
increasing the cost of a second path segment of the available path segments based on historical data indicating a high risk of encountering an obstacle on the first path segment, wherein a decreased cost corresponds to an increased path speed for the first path segment.

24. The method of claim 21, wherein assigning the costs to the plurality of available path segments comprises:
determining a path speed for each of the plurality of available path segments based on the data indicating risk of encountering an obstacle along the available path segment; and
estimating a travel time for each of the plurality of available path segments based on the determined path speeds,
wherein the assigned costs correspond to the estimated travel times of the plurality of available path segments.

25. The method of claim 24, wherein:
the determined path speeds comprise a low path speed and a high path speed;
the low path speed corresponds to a speed at which a drone is expected to be able to stop in time when a sensor of the drone detects an obstacle; and
the high path speed corresponds to a speed that exceeds an expected stopping ability of the drone when the sensor of the drone detects an obstacle.

26. The method of claim 21, further comprising:
determining a low path speed for a first available path segment of the plurality of available path segments, wherein the low path speed corresponds to a speed at which a drone is expected to be able to stop in time when a sensor of the drone detects an obstacle; and
in response to the drone traveling the first available path segment without encountering an obstacle, changing the path speed for the first available path segment to a high path speed that exceeds an expected stopping ability of the drone when the sensor of the drone detects an obstacle.

27. The method of claim 21, wherein the available path segments are available path segments in a warehouse, the method further comprising:
resetting one or more of the assigned costs at least once a day.

28. The method of claim 21, further comprising:
navigating a drone along the path to a destination;
identifying an obstacle along the path;
accessing a path planning graph;
generating a modified path planning graph based on the identified obstacle and the accessed path planning graph; and
determining an alternate path to the destination based on the modified path planning graph.

29. The method of claim 28, further comprising:
determining whether the identified obstacle expired, wherein determining whether the identified obstacle expired comprises one of (1) setting a timer and determining whether the timer expired or (2) receiving a report from another drone indicating that it did not encounter the obstacle; and
in response to determining that the identified obstacle expired, restoring the path planning graph.

30. A system comprising:
a memory storing instructions; and
processing circuitry configured to execute the instructions stored in the memory to:
assign costs to a plurality of available path segments based on data indicating risk of encountering obstacles; and
determine a path from a starting point to an ending point based on the assigned costs.

31. The system of claim 30, wherein the processing circuitry is further configured to modify at least one cost corresponding to at least one path segment of the available path segments based on data indicating a change in risk of encountering an obstacle on the at least one path segment.

32. The system of claim 31, wherein the processing circuitry is configured to modify the at least one cost corresponding to the at least one path segment by:
decreasing the cost of a first path segment based on historical data indicating a low risk of encountering an obstacle on the first path segment, wherein a decreased cost corresponds to an increased path speed for the first path segment; and
increasing the cost of a second path segment of the available path segments based on historical data indicating a high risk of encountering an obstacle on the first path segment, wherein a decreased cost corresponds to an increased path speed for the first path segment.

33. The system of claim 30, wherein the processing circuitry is configured to assign the costs to the plurality of available path segments by:
determining a path speed for each of the plurality of available path segments based on the data indicating risk of encountering an obstacle along the available path segment; and
estimating a travel time for each of the plurality of available path segments based on the determined path speeds,
wherein the assigned costs correspond to the estimated travel times of the plurality of available path segments.

34. The system of claim 33, wherein:
the determined path speeds comprise a low path speed and a high path speed;
the low path speed corresponds to a speed at which a drone is expected to be able to stop in time when a sensor of the drone detects an obstacle; and
the high path speed corresponds to a speed that exceeds an expected stopping ability of the drone when the sensor of the drone detects an obstacle.

35. The system of claim 30, wherein the processing circuitry is further configured to:
determine a low path speed for a first available path segment of the plurality of available path segments, wherein the low path speed corresponds to a speed at which a drone is expected to be able to stop in time when a sensor of the drone detects an obstacle; and
in response to the drone traveling the first available path segment without encountering an obstacle, change the path speed for the first available path segment to a high path speed that exceeds an expected stopping ability of the drone when the sensor of the drone detects an obstacle.

36. The system of claim 30, wherein the available path segments are available path segments in a warehouse and wherein the processing circuitry is further configured to:
reset one or more of the assigned costs at least once a day.

37. The system of claim 30, wherein the processing circuitry is further configured to:
navigate a drone along the path to a destination;
identify an obstacle along the path;
access a path planning graph;
generate a modified path planning graph based on the identified obstacle and the accessed path planning graph; and
determine an alternate path to the destination based on the modified path planning graph.

38. The system of claim 37, wherein the processing circuitry is further configured to:
determine whether the identified obstacle expired by one of (1) setting a timer and determining whether the timer expired or (2) receiving a report from another drone indicating that it did not encounter the obstacle; and
in response to determining that the identified obstacle expired, restore the path planning graph.

39. A non-transitory computer-readable medium comprising non-transitory computer-readable instructions encoded thereon for determining a path, the instructions comprising instructions for:
assigning costs to a plurality of available path segments based on data indicating risk of encountering obstacles; and
determining the path from a starting point to an ending point based on the assigned costs.

40. The non-transitory computer-readable medium of claim 39, wherein the processing circuitry is further configured to modify at least one cost corresponding to at least one path segment of the available path segments based on data indicating a change in risk of encountering an obstacle on the at least one path segment by:
decreasing the cost of a first path segment based on historical data indicating a low risk of encountering an obstacle on the first path segment, wherein a decreased cost corresponds to an increased path speed for the first path segment; and
increasing the cost of a second path segment of the available path segments based on historical data indicating a high risk of encountering an obstacle on the first path segment, wherein a decreased cost corresponds to an increased path speed for the first path segment.
